(19) United States
(12) Patent Application Publication
(10) Pub. No.: US 2015/0046756 A1
(43) Pub. Date: Feb. 12, 2015

(54) PREDICTIVE FAILURE ANALYSIS TO TRIGGER REBUILD OF A DRIVE IN A RAID ARRAY

(71) Applicant: LSI Corporation, San Jose, CA (US)

(72) Inventors: Dipu Sreekumaran, Bangalore (IN); Abin Sreedharan Leela, Bangalore (IN); Safeer Asanarukunju, Bangalore (IN)

(73) Assignee: LSI Corporation, San Jose, CA (US)

(21) Appl. No.: 13/970,921

(22) Filed: Aug. 20, 2013

Related U.S. Application Data
(60) Provisional application No. 61/863,620, filed on Aug. 8, 2013.

(51) Int. Cl. G06F 11/00

(52) U.S. Cl. CPC G06F 11/008
USPC 714/47.2

(57) ABSTRACT

An apparatus comprising a first interface, a second interface and a processor. The first interface may be configured to connect to a host device. The second interface may be configured to connect to a plurality of drives. The processor may be configured to (i) periodically read a drive attribute from each of the drives, (ii) determine a risk factor based on the attribute, (iii) determine if each of the drives is likely to fail based on the risk factor, (iv) determine a cost factor for each of the drives determined to be likely to fail, (v) determine a threshold risk factor based on the cost factor for each of the drives determined to be likely to fail and (vi) if one of the drives is determined to be likely to fail and if the risk factor is more than the threshold risk factor, replace the drive determined to be likely to fail prior to the failure.

This application relates to U.S. Provisional Application No. 61/863,620, filed Aug. 8, 2013, which is hereby incorporated by reference in its entirety.

### FIELD OF THE INVENTION

The invention relates to drive arrays generally and, more particularly, to a method and/or apparatus for implementing a predictive failure analysis to trigger rebuild of a drive in a RAID array.

### BACKGROUND

Predictive failure analysis (PFA) is a system where a computer hard disk drive detects and reports various indicators of reliability in an effort to predict drive failure. This is sometimes referred to as Self-Monitoring Analysis and Reporting Technology (SMART). Storage systems implement RAID (Redundant Array of Independent Disks) as a technology to combine multiple disk drives into a single logical unit for redundancy and/or performance. A rebuild is triggered after a disk failure on a RAID volume to re-create a mirror or parity arm.

### SUMMARY

The invention concerns an apparatus comprising a first interface, a second interface and a processor. The first interface may be configured to connect to a host device. The second interface may be configured to connect to a plurality of drives. The processor may be configured to (i) periodically read a drive attribute from each of the drives, (ii) determine a risk factor based on the attribute, (iii) determine if each of the drives is likely to fail based on the risk factor, (iv) determine a cost factor for each of the drives determined to be likely to fail, (v) determine a threshold risk factor based on the cost factor for each of the drives determined to be likely to fail and (vi) if one of the drives is determined to be likely to fail and if the risk factor is more than the threshold risk factor, replace the drive determined to be likely to fail prior to the failure.

### BRIEF DESCRIPTION OF THE FIGURES

Embodiments of the invention will be apparent from the following detailed description and the appended claims and drawings in which:

FIG. 1 is a block diagram of an overall architecture of the invention;

FIG. 2 is a diagram of various readings of a failed drive;

FIG. 3 is a diagram of various readings of a reference drive;

FIG. 4 is a diagram of various readings of a drive that did not fail; and

FIG. 5 is a flow diagram of a process for determining a drive replacement.

### DETAILED DESCRIPTION OF THE EMBODIMENTS

Embodiments of the invention include providing a predictive failure analysis that may (i) be used in a drive array, (ii) determine a likelihood of a drive failure, and/or (iii) trigger a rebuild on one or more drives in the array if certain conditions are met.

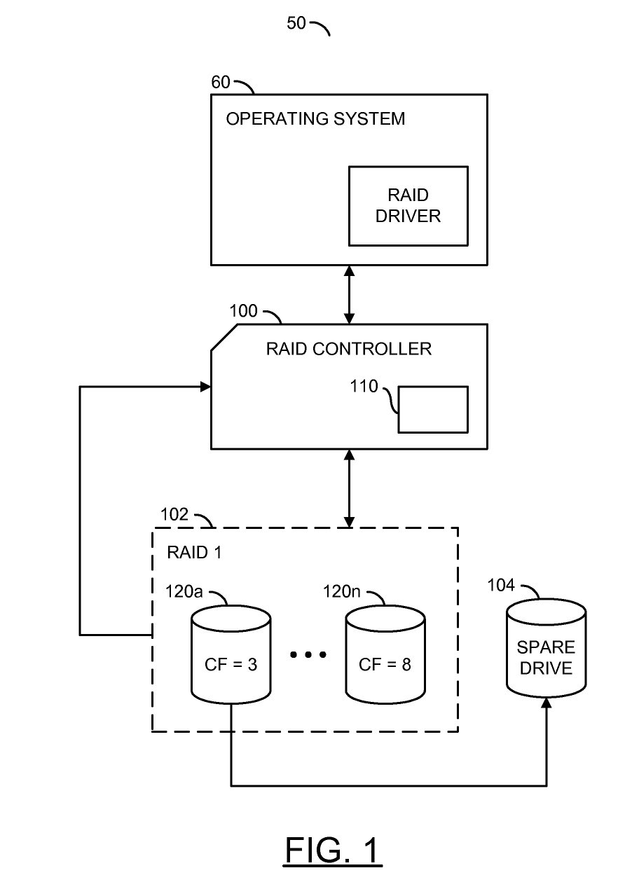

Referring to FIG. 1, a block diagram of a system 50 is shown in accordance with an embodiment of the invention. The system 50 generally comprises a host 60, a block (or circuit) 100, a block (or circuit) 102, and a block (or circuit) 104. The circuit 102 may include one or more drives 120a-120n. The particular number of drives 120a-120n implemented may be varied to meet the design criteria of a particular implementation. The circuit 100 may be implemented as a Redundant Array of Inexpensive Drives (RAID) controller. The circuit 102 may be implemented as a storage array, such as a RAID 1 drive configuration. Other RAID configurations, such as RAID3, RAIDS, etc. may be implemented. Depending on the type of RAID configuration, the number of drives 120a-120n may be increased and/or decreased. The circuit 104 may be implemented as a drive used as a spare storage device. For example, the drive 104 may be used to replace one of the drives 120a-120n in the event of a failure.

The controller 100 may include a block (or circuit) 110. The circuit 110 may be implemented as firmware, or hardware used to control the various aspects of the controller 100. The circuit 110 may have a memory/processor configured to store computer instructions. The instructions, when executed, may perform a number of steps. The block 110 may include instructions to control the overall RAID operations (e.g., I/O requests, etc.) and/or instructions to implement the predictive rebuild described.

In one example, the system 50 collects one or more drive attributes from each of the drives 120a-120n. The attributes may be collected at periodic intervals. The attributes may comprise one or more SMART (Self-Monitoring Analysis and Reporting Technology) attributes. However, other attributes may be implemented or collected to meet the design criteria of a particular application. The attributes may be used to predict failure of a particular one of the drives 120a-120n. The circuit 110 may determine whether (or when) to trigger a rebuild of one or more of the drives 120a-120n of the RAID volume. The decision may take into account overall system usage to minimize data unavailability. The circuit 110 also takes into account the cost of the drives 120a-120n to improve better utilization of costly drives. For example, if a drive is costly, the controller 100 may determine that a replacement may be delayed. If a replacement is delayed, a report may be generated and sent to an administrator. The administrator may then determine whether to proactively replace the drive, or use the drive as long as possible before a failure.

The SMART attributes may be used to predict a failure of one or more of the drives 120a-120n. If the prediction is made in advance, with a fair amount of accuracy, the RAID firmware 110 can trigger a rebuild on a hot spare. Proactively replacing one of the drives 120a-120n helps to prevent a number of issues which are faced when using conventional approaches that reactively trigger a rebuild after a drive fails.

For example, without the controller 100 proactively replacing a bad (e.g., ready to fail) one of the drives 120a-120n, if a second drive also fails (e.g., a double disk failure) before rebuild is complete, data loss may occur. Without the controller 100 proactively replacing a bad one or more of the drives 120a-120n, if a media error is encountered on the second disk during a rebuild, the data on the sector will become unrecoverable since the first disk has already failed. Without the controller 100 proactively replacing a bad one of the drives 120a-120n, if the rebuild is triggered after the drive fails, read performance will suffer until the rebuild is complete.

The controller 100 may use one or more drive attributes, such as SMART attributes, reported by the drives 120a-120n to calculate a Risk Factor (RF) (or value) for each of the drives 120a-120n. The risk factor RF, along with a Cost Factor (CF) of the drives 120a-120n may be used to make a decision on whether a rebuild should be triggered or not. Deciding whether to proactively replace one or more of the drives 120a-120n will ultimately reduce a Period of Exposure (POE) of the array. The Period of Exposure may be defined as the time elapsed between the first drive going bad and rebuild completion on the new disk. In general, the POE is the time period when there is a threat of data loss. The POE=(Time of rebuild completion−Time of first disk going bad) Risk Factor (RF). Proactive replacement also reduces the risk of data loss issues due to potential double disc failures.

The risk factor RF is calculated based on attributes reported by each of the drives 120a-120n. In one example, calculating the risk factor RF may use a system such as “Individual comparisons by ranking methods” by F. Wilcoxon (Biometrica, vol. 1, 1945), the appropriate portions of which are incorporated by reference. Rank-sum tests are recommended for situations where false-alarm rates are costly, as discussed by Hughes et al., “Improved disk-drive failure warnings” (IEEE Transactions on Reliability, September 2002), the appropriate portions of which are incorporated by reference, which discusses how to use Wilcoxon rank-sum method in the context of predicting disk failures. Similar processes may be used to calculate the risk factor RF for each of the drives 120a-120n as discussed by Pinheiro et al., “Failure Trends in a Large Disk Drive Population” (Proceedings of the 5th USENIX Conference on File and Storage Technologies, 2007).

The SMART data attributes referred to are publicly available as discussed by Murray, “Machine Learning Methods for Predicting Failures in Hard Drives: A Multiple-Instance Application” (Journal of Machine Learning Research, vol. 6, 2005), the appropriate portions of which are incorporated by reference. Sample data from 369 drives are available and each is labeled as good or failed. 178 drives are in good class and 191 in failed class.

The controller 100 calculates a rank-sum value for each of the SMART attributes of each of the drives 120a-120n based on Wilcoxon rank-sum method. As an example, read errors on the drives 120a-120n are considered. For calculating rank-sum, a reference data set is needed. The following TABLE 1 shows a reference data set being used based on read errors on 10 out of 178 good drives in the sample data:

TABLE 1

| Drive No. | Average | Median |
|---|---|---|
| 360 | 14.92 | 9 |
| 361 | 1.16 | 0 |
| 362 | 0.71 | 0 |
| 363 | 0.73 | 0 |
| 364 | 16.49 | 4 |
| 365 | 39.68 | 8 |
| 366 | 4.36 | 4.5 |
| 367 | 1.87 | 1 |
| 368 | 7.36 | 2 |
| 369 | 1.17 | 0 |

The following TABLE 2 shows a second set of data as the latest 10 samples from a failed drive:

TABLE 2

| Interval | Read Error Count |
|---|---|
| 1 | 0 |
| 2 | 4 |
| 3 | 0 |
| 4 | 0 |
| 5 | 0 |
| 6 | 1 |
| 7 | 2 |
| 8 | 1 |
| 9 | 1 |
| 10 | 1 |

Each sample data is taken at 2 hour intervals from one of the drives 120a-120n. The test method combines both the data sets in a sorted order and gives a rank to each of the data values. When duplicate data values occur, the rank value uses an average of the values. For example, 8 data values are shown with value 0. All of the data with a value 0 will get a rank of (8+1)/2=4.5.

In one example, the rank-sum value for the Warning Data Set is calculated as follows:

Rank-Sum/Risk Factor for seek errors=4.5+4.5+4.5+4.5+11+11+11+11+14.5+16.5=93

The following TABLE 3 shows an example of a rank-sum calculation. Reference data is shown shaded:

TABLE 3

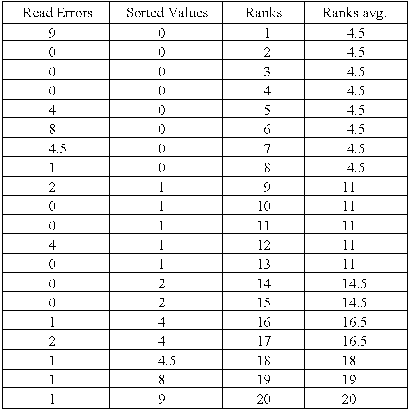

The following TABLE 4 shows a total risk factor (TRF) for each cost factor:

TABLE 4

| Cost Factor | TRF |
|---|---|
| 1 | 110 |
| 2 | 115 |
| 3 | 120 |
| 4 | 125 |
| 5 | 130 |
| 6 | 135 |
| 7 | 140 |
| 8 | 145 |
| 9 | 150 |
| 10 | 155 |

In one example, the cost factor CF is a number between 1 and 10 which is assigned based on the cost of the replacement drive 104. In a simple example, a $70 drive will have a CF of 3 while a $210 drive will have a CF of 8. The cost factor CF is used as the threshold value to trigger rebuild for one of the drives 120a-120n that may be predicted to fail.

The decision on whether a rebuild of one or more of the drives 120a-120n should be triggered is made based on the risk factor RF and the cost factor CF. In one example, the risk factor RF of the warning data set is calculated to be 93. The risk factor RF is compared with a reference value to find out how accurate or not the current warning value is.

In one example, the total number of seek error counts is (e.g., 10 reference+10 warning). If the 20 error counts result from the same probability distribution, then the rank-sum or warning data should be sum of 10 random numbers between 1 and 20. Hence, average rank sum=10(1+20)/2=105. This value is used as Reference Risk Factor (RRF). A maximum rank sum value for 20 values with 10 warning values=Σᵢ₌₁₁²⁰i=155. This value is used as Maximum Risk Factor (MRF).

The range of values between the reference risk factor RRF and the maximum risk factor MRF is divided into 10 intervals, each corresponding to a cost factor CF. Each of the drives 110a-110n is assigned a cost factor CF based on the cost of the drive and the corresponding value in TABLE 4 (e.g., the Threshold Risk Factor TRF for that drive model). Each SMART data sample obtained at a regular interval is used to calculate the corresponding rank sum shown in TABLE 3. If the rank sum exceeds the TRF of the drive, a rebuild is triggered.

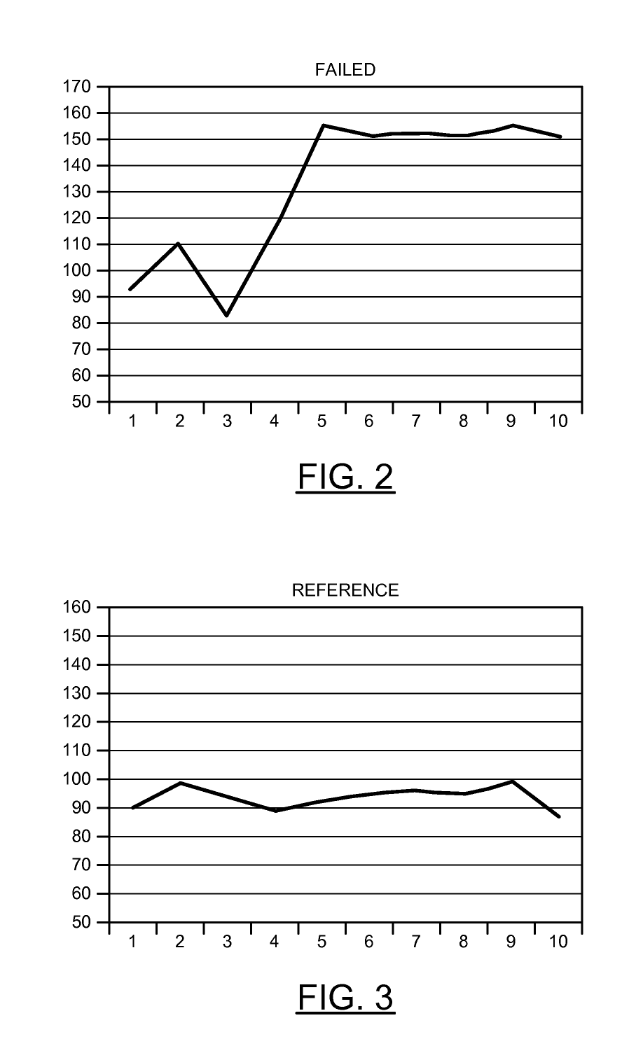

The above method is described based on SMART data obtained from 3 different drives. For all the 3 drives, a risk factor RF can be calculated based on read errors obtained at regular time intervals. The results are plotted in FIGS. 2, 3 and 4. The risk factor RF is plotted on x-axis and time on y-axis.

Referring to FIG. 2, readings for a drive (e.g., Drive 1) collected at 10 different intervals are shown. The drive is chosen from the set of 191 failed drives in our sample data set. From the graph the drive is shown to have hits of the MRF value after the 4^{th} reading. Even if the drive has the maximum cost factor, rebuild will be triggered after the 5^{th} reading. Since the drive ultimately failed, triggering rebuild is a good decision.

Referring to FIG. 3, readings are plotted for a reference drive. The risk factor RF calculated at regular interval stays below the RRF. Even for a drive with a low cost factor CF, rebuild is not triggered for this drive. The decision is justified by the fact that the drive did not fail at the end of the test.

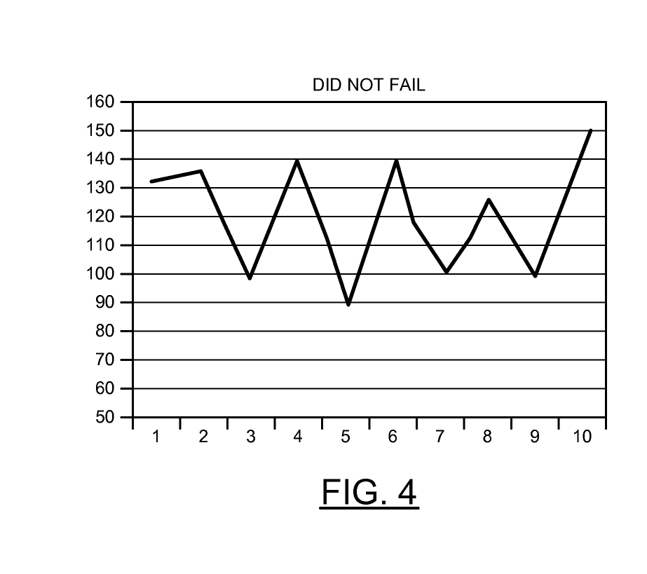

Referring to FIG. 4, readings from a drive that did not fail are shown. This drive is chosen from the set of 178 drives in the good class, which did not fail at the end of the test. The graph plotted in FIG. 4 shows the risk factor RF values swinging widely across the average risk factor (ARF) and maximum risk factor MRF ranges. Based on the graph, irrespective of the cost factor of the drive, triggering a rebuild and replacement of the drive is a good idea. The drive did not fail at the end of the test, but based on the data, there is a very good chance that the drive will fail soon.

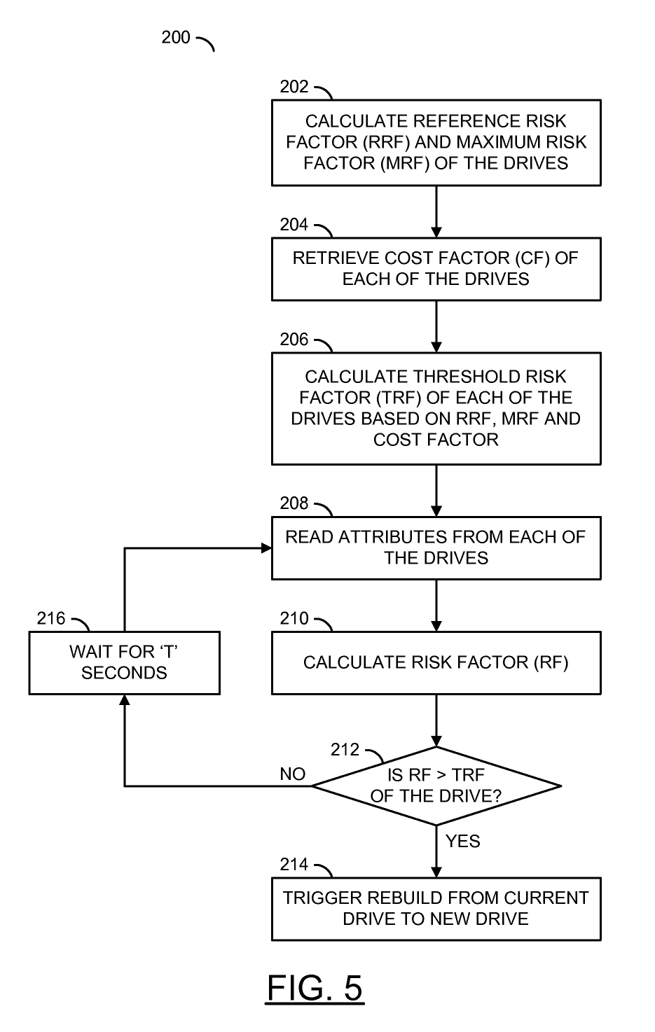

Referring to FIG. 5, a method 200 is shown. The method 200 may be used to calculate whether to replace one of the drives 120a-120n. The method 200 generally comprises a step (or state) 202, a step (or state) 204, a step (or state) 206, a step (or state) 208, a step (or state) 210, a decision step (or state) 212, a step (or state) 214, and a step (or state) 216. The step 202 may calculate the reference risk factor RRF and the maximum risk factor MRF of each of the drives 120a-120n. The step 204 may retrieve the cost factor CF of each of the drives 120a-120n. The step 206 may calculate the threshold risk factor TRF of each of the drives 120a-120n based on the reference risk factor RRF, the maximum risk factor MRF and the cost factor CF. The step 208 may read one or more attributes from each of the drives 120a-120n. The step 210 may calculate the risk factor RF using, for example, a rank-sum method. The step 204 may retrieve the cost factor CF. The cost factor CF may be retrieved from either directly from a user or may read from a configuration file saved by a user. Next, the decision step 212 determines if the risk factor RF is greater than the threshold risk factor TRF for each of the drives 120a-120n. For the drives 120a-120n that the risk factor RF is greater than the threshold risk factor TRF, the method 200 moves to the state 214. The state 214 triggers a rebuild from the current one of the drives 120a-120n to the spare drive 104. If the risk factor RF is not greater than the threshold risk factor, the method 200 moves to the state 216, which waits for “T” seconds. The wait time T may be an interval that may be configured by a user. The method 200 then returns to the step 208.

The circuit 100 reduces the risk of data loss if a second of the drives 110a-110n also fails before rebuild of a first failed one of the drives 110a-110n is completed once a single disk failure is encountered. A rebuild will be started to mirror the second disk to a new disk. Until the rebuild is completed, there is a period of exposure POE. During the POE, data is at risk. The duration of the POE depends on the disk bandwidth and the total data size. There is also a possibility of hitting a media error on the second failed disk which will make data in the sector unrecoverable. Starting the rebuild in advance without waiting for the drive to fail may ensure that read performance of the volume is not affected while rebuild is in progress.

Using the cost factor CF to trigger the rebuild and/or discard of old drive provides several benefits. If two of the drives 110a-110n have the same RF (e.g., similar error count, etc.), both should have similar probability of failure at a certain point in the future. For example, a $900 drive has to be kept operational for 9 months to get the same cost advantage of keeping a $100 drive operational for a month. Extending the lifetime of potentially costly drives 120a-120n, even for few weeks, provides a cost advantage compared to extending less expensive drives. The circuit 100 is normally applied on mirrored volumes. Some amount of risk may be set by adjusting a higher rebuild threshold values (CF) for the costlier drives. A costlier drive may have a better quality and/or would normally last longer than a cheaper drive having the same risk RF value. If certain brands of drives 120a-120n are later found to be less reliable than initially expected (e.g., a reliability trend), the cost factor CF and/or risk factor RF may be adjusted after an initial installation of the circuit 100.

The functions performed by the diagram of FIG. 5 may be implemented using one or more of a conventional general purpose processor, digital computer, microprocessor, microcontroller, RISC (reduced instruction set computer) processor, CISC (complex instruction set computer) processor, SIMD (single instruction multiple data) processor, signal processor, central processing unit (CPU), arithmetic logic unit (ALU), video digital signal processor (VDSP) and/or similar computational machines, programmed according to the teachings of the specification, as will be apparent to those skilled in the relevant art(s). Appropriate software, firmware, coding, routines, instructions, opcodes, microcode, and/or program modules may readily be prepared by skilled programmers based on the teachings of the disclosure, as will also be apparent to those skilled in the relevant art(s). The software is generally executed from a medium or several media by one or more of the processors of the machine implementation.

The invention may also be implemented by the preparation of ASICs (application specific integrated circuits), Platform ASICs, FPGAs (field programmable gate arrays), PLDs (programmable logic devices), CPLDs (complex programmable logic devices), sea-of-gates, RFICs (radio frequency integrated circuits), ASSPs (application specific standard products), one or more monolithic integrated circuits, one or more chips or die arranged as flip-chip modules and/or multi-chip modules or by interconnecting an appropriate network of conventional component circuits, as is described herein, modifications of which will be readily apparent to those skilled in the art(s).

The invention thus may also include a computer product which may be a storage medium or media and/or a transmission medium or media including instructions which may be used to program a machine to perform one or more processes or methods in accordance with the invention. Execution of instructions contained in the computer product by the machine, along with operations of surrounding circuitry, may transform input data into one or more files on the storage medium and/or one or more output signals representative of a physical object or substance, such as an audio and/or visual depiction. The storage medium may include, but is not limited to, any type of disk including floppy disk, hard drive, magnetic disk, optical disk, CD-ROM, DVD and magneto-optical disks and circuits such as ROMs (read-only memories), RAMs (random access memories), EPROMs (erasable programmable ROMs), EEPROMs (electrically erasable programmable ROMs), UVPROM (ultra-violet erasable programmable ROMs), Flash memory, magnetic cards, optical cards, and/or any type of media suitable for storing electronic instructions.

The elements of the invention may form part or all of one or more devices, units, components, systems, machines and/or apparatuses. The devices may include, but are not limited to, servers, workstations, storage array controllers, storage systems, personal computers, laptop computers, notebook computers, palm computers, personal digital assistants, portable electronic devices, battery powered devices, set-top boxes, encoders, decoders, transcoders, compressors, decompressors, pre-processors, post-processors, transmitters, receivers, transceivers, cipher circuits, cellular telephones, digital cameras, positioning and/or navigation systems, medical equipment, heads-up displays, wireless devices, audio recording, audio storage and/or audio playback devices, video recording, video storage and/or video playback devices, game platforms, peripherals and/or multi-chip modules. Those skilled in the relevant art(s) would understand that the elements of the invention may be implemented in other types of devices to meet the criteria of a particular application.

The terms “may” and “generally” when used herein in conjunction with “is(are)” and verbs are meant to communicate the intention that the description is exemplary and believed to be broad enough to encompass both the specific examples presented in the disclosure as well as alternative examples that could be derived based on the disclosure. The terms “may” and “generally” as used herein should not be construed to necessarily imply the desirability or possibility of omitting a corresponding element.

While the invention has been particularly shown and described with reference to embodiments thereof, it will be understood by those skilled in the art that various changes in form and details may be made without departing from the scope of the invention.

1. An apparatus comprising:
a first interface configured to connect to a host device;
a second interface configured to connect to a plurality of drives; and
a processor configured to (i) periodically read a drive attribute from each of said drives, (ii) determine a risk factor based on the attribute, (iii) determine if each of said drives is likely to fail based on said risk factor, (iv) determine a cost factor for each of said drives determined to be likely to fail, (v) determine a threshold risk factor based on the cost factor for each of the drives determined to be likely to fail and (v) if one of said drives is determined to be likely to fail and if said risk factor is more than said threshold risk factor, replace said drive determined to be likely to fail prior to said failure.

2. The apparatus according to claim 1, wherein said cost factor is increased if said attributes indicate data on said drive likely to fail will become unreadable.

3. The apparatus according to claim 1, wherein said plurality of drives are configured as a Redundant Array of Inexpensive Drives (RAID).

4. The apparatus according to claim 1, wherein said processor determines which one or more of said drives is likely to fail by calculating said risk factor for each of said drives.

5. The apparatus according to claim 1, wherein said cost factor represents a cost to replace one of said drives.

6. The apparatus according to claim 1, wherein said risk factor is adjusted based on reliability trends of said drives.

7. The apparatus according to claim 1, wherein said risk factor is calculated at a regular interval after each periodic read of said drive attribute.

8. The apparatus according to claim 7, wherein said regular interval is configurable.

9. The apparatus according to claim 1, wherein said apparatus implements a predictive failure analysis used to trigger a rebuild in a drive array.

10. The apparatus according to claim 1, wherein said processor balances system usage to minimize data unavailability.

11. The apparatus according to claim 1, wherein said processor is configured to send a report to an administrator if said cost factor is greater than said predetermined cost.

12. A method for initiating a rebuild of a drive in an array, comprising the steps of:
(A) reading a drive attribute from each of said drives at a periodic interval;
(B) determining a risk factor based on the attribute;
(C) determining if each of said drives is likely to fail based on said risk factor;
(D) determining a cost factor for each of said drives determined to be likely to fail;
(E) determining a threshold risk factor based on the cost factor for each of the drives determined to be likely to fail; and
(F) if one of said drives is determined to be likely to fail and if said risk factor is more than said threshold risk factor, replacing said drive determined to be likely to fail prior to said failure.

13. The method according to claim 12, wherein said risk factor used to determine if each of said drives is likely to fail is adjusted based on reliability trends of said drives.

14. The method according to claim 12, wherein said method balances system usage to minimize data unavailability.

15. The method according to claim 12, wherein said method is configured to send a report to an administrator if said cost factor is greater than said predetermined cost.
